(19) United States
(12) Patent Application Publication
(10) Pub. No.: US 2024/0010211 A1
(43) Pub. Date: Jan. 11, 2024

(54) SYSTEMS AND METHODS FOR SELECTIVELY USING A VEHICLE TRAJECTORY

(71) Applicant: FORD GLOBAL TECHNOLOGIES, LLC, Dearborn, MI (US)

(72) Inventors: Stuart Lowe, Pittsburgh, PA (US); Tilmann Ochs, Eching (DE)

(21) Appl. No.: 17/811,328

(22) Filed: Jul. 8, 2022

(51) Int. Cl. B60W 50/029; B60W 60/00

(52) U.S. Cl. CPC B60W 50/029; B60W 60/0015

(57) ABSTRACT

Disclosed herein are systems, methods, and computer program products for selectively using vehicle trajectories. The methods comprise: receiving a vehicle trajectory (VT) prior to being used to generate motion commands (MCs) for a vehicle; identifying software and/or hardware components of the vehicle that produced data used to generate VT; determining whether a fault condition exists that is associated with VT based on (i) a detection that the software/hardware component(s) did or did not experience a fault or operational condition of a type while producing the data used to generate VT and/or (ii) a detection that VT would or would not cause violation of limit(s) for an operational parameter of the vehicle; selecting VT when the fault condition does not exist or another VT when the fault condition does exist; and causing the motion commands to be generated using VT or the another VT which was selected.

### BACKGROUND

Modern day vehicles have at least one on-board computer and have internet/satellite connectivity. The software running on these on-board computers monitor and/or control operations of the vehicles. The vehicle also comprises monocular or stereo cameras, radars and/or lidar detectors for detecting objects in proximity thereto. The cameras capture images of a scene. The radars generate information specifying ranges to illuminated targets. The lidar detectors generate lidar datasets that measure the distance from the vehicle to an object at a plurality of different times. These images, ranges and distance measurements can be used for detecting and tracking movements of the object, making predictions as to the object's trajectory, and planning paths of travel for the vehicle based on the predicted objects trajectory.

A travel plan for a vehicle may comprise a spatial plan (for example, a trajectory defined by x-coordinates, y-coordinates and yaw displacements) and a speed plan (for example, velocity value(s), longitudinal acceleration parameter value(s) and/or deceleration parameter value(s)). The trajectory is used by various systems to control movement and other operations of the vehicle. The trajectory may have been generated using data produced by faulty hardware and/or software. Such a trajectory could have undesirable consequences when used to control operations of the vehicle.

This document describes methods and systems that are directed to addressing the problems described above, and/or other issues.

### SUMMARY

The present disclosure concerns implementing systems and methods for selectively using vehicle trajectories. The methods comprise performing the following operations by a computing device: receiving a vehicle trajectory prior to being used to generate motion commands for the vehicle; identifying software operations and hardware components of the vehicle that produced data used to generate the vehicle trajectory; determining whether or not a fault condition exists that is associated with the vehicle trajectory based on (i) a detection that at least one of the identified software operations and hardware components did or did not experience a fault or operational condition of a type while producing the data used to generate the vehicle trajectory and/or (ii) a detection that the vehicle trajectory would or would not cause violation of at least one limit for an operational parameter of the vehicle; performing operations to select the vehicle trajectory when the fault condition does not exist or to select another vehicle trajectory when the fault condition does exist; and/or causing the motion commands to be generated using the vehicle trajectory or the another vehicle trajectory which was selected.

The implementing systems can comprise: a processor; and a non-transitory computer-readable storage medium comprising programming instructions that are configured to cause the processor to implement a method for operating an automated system. The above-described methods can also be implemented by a computer program product comprising memory and programming instructions that are configured to cause a processor to perform operations.

### BRIEF DESCRIPTION OF THE DRAWINGS

The accompanying drawings are incorporated herein and form a part of the specification.

FIG. 1 is an illustration of an illustrative system.

FIG. 2 is an illustration of an illustrative architecture for a vehicle.

FIG. 3 is an illustration of an illustrative computing device.

FIG. 4 provides a block diagram of an illustrative vehicle trajectory planning process.

FIG. 5 provides an illustration that is useful for understanding timing of fault detection and reaction operations by a system.

FIG. 6 provides an illustration of a vehicle trajectory planning process in accordance with the present solution.

FIG. 7 provides an illustration of another vehicle planning process in accordance with the present solution.

FIGS. 8A-8B (collectively referred to as “FIG. 8”) provides a flow diagram of an illustrative method for selectively using vehicle trajectories.

FIG. 9 provides a flow diagram of another illustrative method for selectively using vehicle trajectories.

In the drawings, like reference numbers generally indicate identical or similar elements. Additionally, generally, the leftmost digit(s) of a reference number identifies the drawing in which the reference number first appears.

### DETAILED DESCRIPTION

As noted above, a vehicle path generator performs operations to generate a vehicle trajectory that may be defined by x-coordinates, y-coordinates and yaw displacements over time. The vehicle trajectory may be used by various downstream functions and/or systems to control movement and other operations of the vehicle. The vehicle trajectory may have been generated using data output from faulty hardware and/or software. Such a vehicle trajectory could have undesirable consequences when used to control operations of the vehicle. The purpose of the present solution is to provide a functional guarantor of the vehicle trajectory health eliminating or reducing faults and failures from cascading through the system into downstream functions and/or systems (for example, downstream path followers and vehicle motion controllers).

The present solution generally concerns implementing systems and methods for selectively using vehicle trajectories. The methods comprise performing the following operations by a computing device: receiving a vehicle trajectory prior to being used to generate motion commands for the vehicle; identifying software operations and hardware components of the vehicle that produced data used to generate the vehicle trajectory; determining whether or not a fault condition exists that is associated with the vehicle trajectory based on (i) a detection that at least one of the identified software operations and hardware components did or did not experience a fault or operational condition of a pre-defined type while producing the data used to generate the vehicle trajectory and/or (ii) a detection that the vehicle trajectory would or would not cause violation of at least one pre-defined limit for an operational parameter of the vehicle; performing operations to select the vehicle trajectory when the fault condition does not exist or to select another vehicle trajectory when the fault condition does exist; and/or causing the motion commands to be generated using the vehicle trajectory or the another vehicle trajectory which was selected. The another vehicle trajectory is different than the vehicle trajectory.

As used in this document, the singular forms “a,” “an,” and “the” include plural references unless the context clearly dictates otherwise. Unless defined otherwise, all technical and scientific terms used herein have the same meanings as commonly understood by one of ordinary skills in the art. As used in this document, the term “comprising” means “including, but not limited to.” Definitions for additional terms that are relevant to this document are included at the end of this Detailed Description.

An “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, semi-autonomous vehicles, manually operated vehicles, teleoperated vehicles, watercraft, aircraft, aerial drones and the like. An “autonomous vehicle” (or “AV”) is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle.

In this document, when terms such as “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

Notably, the present solution is being described herein in the context of autonomous vehicles. However, the present solution is not limited to autonomous vehicle applications. The present solution can be used in other applications such as robotic application (for example to control movements of articulating arms) and/or system performance applications.

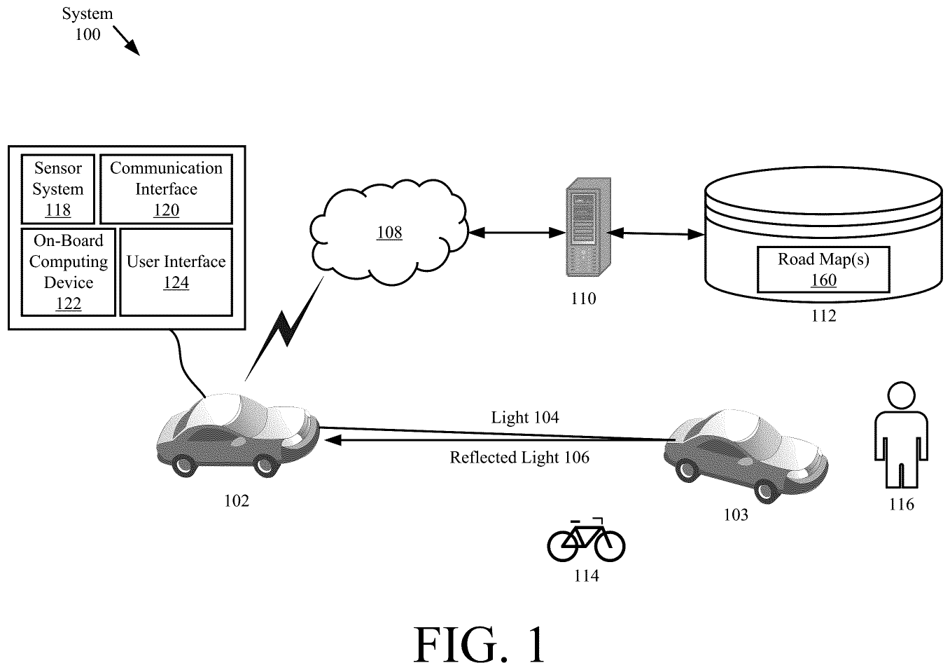

FIG. 1 illustrates an example system 100, in accordance with aspects of the disclosure System 100 comprises a vehicle 102 which is caused to travel along a road in a semi-autonomous or autonomous manner. Vehicle 102 is also referred to herein as an AV 102. The AV 102 can include, but is not limited to, land vehicles (as shown in FIG. 1), aircraft, watercraft, subterrenes, spacecraft, drones and/or an articulating arm (for example, with a gripper at a free end). As noted above, except where specifically noted this disclosure is not necessarily limited to AV embodiments, and it may include non-autonomous vehicles in some embodiments.

AV 102 is generally configured to detect objects 103, 114, 116 in proximity thereto. The objects can include, but are not limited to, a vehicle 103, a cyclist 114 (such as a rider of a bicycle, electric scooter, motorcycle, or the like) and/or a pedestrian 116.

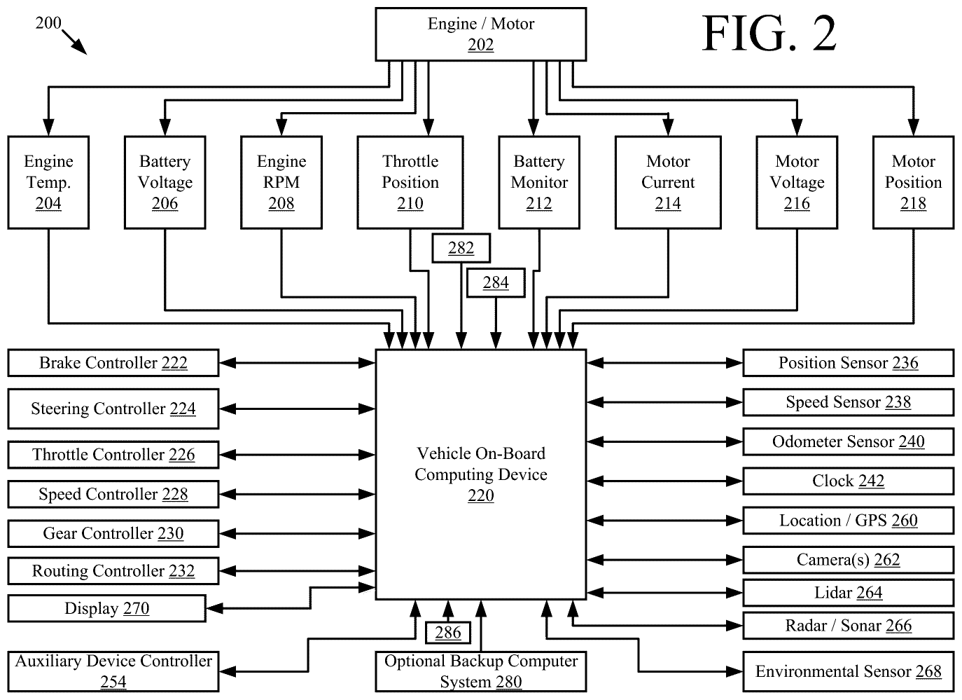

As illustrated in FIG. 1, the AV 102 may include a sensor system 118, an on-board computing device 122, a communications interface 120, and a user interface 124. AV 102 may further include certain components (as illustrated, for example, in FIG. 2) included in vehicles, which may be controlled by the on-board computing device 122 using a variety of communication signals and/or commands, such as, for example, acceleration signals or commands, deceleration signals or commands, steering signals or commands, braking signals or commands, etc.

The sensor system 118 may include one or more sensors that are coupled to and/or are included within the AV 102, as illustrated in FIG. 2. For example, such sensors may include, without limitation, a lidar system, a RADAR system, a laser detection and ranging (LADAR) system, a sound navigation and ranging (SONAR) system, camera(s) (for example, visible spectrum camera(s), infrared camera(s), etc.), temperature sensors, position sensors (for example, a global positioning system (GPS), etc.), location sensors, fuel sensors, motion sensors (for example, an inertial measurement unit (IMU), etc.), humidity sensors, occupancy sensors, and/or the like. The sensors are generally configured to generate sensor data. The sensor data can include information that describes the location of objects within the surrounding environment of the AV 102, information about the environment itself, information about the motion of the AV 102, information about a route of the vehicle, and/or the like. As AV 102 travels over a surface (for example, a road), at least some of the sensors may collect data pertaining to the surface.

As will be described in greater detail, AV 102 may be configured with a lidar system (for example, lidar system 264 of FIG. 2). The lidar system may be configured to transmit a light pulse 104 to detect objects located within a distance or range of distances of AV 102. Light pulse 104 may be incident on one or more objects (for example, AV 103) and be reflected back to the lidar system. Reflected light pulse 106 incident on the lidar system may be processed to determine a distance of that object to AV 102. The reflected light pulse 106 may be detected using, in some scenarios, a photodetector or array of photodetectors positioned and configured to receive the light reflected back into the lidar system. Lidar information, such as detected object data, is communicated from the lidar system to the on-board computing device 122. The AV 102 may also communicate lidar data to a remote computing device 110 (for example, a cloud processing system) over a network 108. Computing device 110 may be configured with one or more servers to process one or more processes of the technology described herein. Computing device 110 may also be configured to communicate data/instructions to/from AV 102 over network 108, to/from server(s) and/or database(s) 112.

It should be noted that the lidar systems for collecting data pertaining to the surface may be included in systems other than the AV 102 such as, without limitation, other vehicles (autonomous or driven), robots, satellites, etc.

Network 108 may include one or more wired or wireless networks. For example, the network 108 may include a cellular network (for example, a long-term evolution (LTE) network, a code division multiple access (CDMA) network, a 3G network, a 4G network, a 5G network, another type of next generation network, etc.). The network may also include a public land mobile network (PLMN), a local area network (LAN), a wide area network (WAN), a metropolitan area network (MAN), a telephone network (for example, the Public Switched Telephone Network (PSTN)), a private network, an ad hoc network, an intranet, the Internet, a fiber optic-based network, a cloud computing network, and/or the like, and/or a combination of these or other types of networks.

AV 102 may retrieve, receive, display, and edit information generated from a local application or delivered via network 108 from the database 112. Database 112 may be configured to store and supply raw data, indexed data, structured data, map data, program instructions or other configurations as is known.

The communications interface 120 may be configured to allow communication between AV 102 and external systems, such as, for example, external devices, sensors, other vehicles, servers, data stores, databases, etc. The communications interface 120 may utilize any now or hereafter known protocols, protection schemes, encodings, formats, packaging, etc. such as, without limitation, Wi-Fi, an infrared link, Bluetooth, etc. The user interface 124 may be part of peripheral devices implemented within the AV 102 including, for example, a keyboard, a touch screen display device, a microphone, and a speaker, etc. The vehicle also may receive state information, descriptive information or other information about devices or objects in its environment via the communication interface 120 over communication links such as those known as vehicle-to-vehicle, vehicle-to-object or other V2X communication links. The term “V2X” refers to a communication between a vehicle and any object that the vehicle may encounter or affect in its environment.

As noted above, the AV 102 may detect objects 103, 114, 116 in proximity thereto. Such object detections are facilitated using the sensor data generated by the sensor system 118 (for example, lidar datasets generated by an onboard lidar detector). The sensor data is processed by the onboard computing device 122 of the AV 102 and/or by the remote computing device 110 to obtain one or more predicted trajectories for the object given the sensor data. The predicted trajectories for the object may then be used to generate a trajectory for the AV 102. The AV 103 may then be caused by the on-board computing device to follow the trajectory.

FIG. 2 illustrates a system architecture 200 for a vehicle, in accordance with aspects of the disclosure. Vehicles 102 and/or 103 of FIG. 1 can have the same or similar system architecture as that shown in FIG. 2. Thus, the following discussion of system architecture 200 is sufficient for understanding vehicle(s) 102, 103 of FIG. 1. However, other types of vehicles are considered within the scope of the technology described herein and may contain more or less elements as described in association with FIG. 2. As a non-limiting example, an airborne vehicle may exclude brake or gear controllers, but may include an altitude sensor. In another non-limiting example, a water-based vehicle may include a depth sensor. One skilled in the art will appreciate that other propulsion systems, sensors and controllers may be included based on a type of vehicle, as is known.

As shown in FIG. 2, the system architecture 200 includes an engine or motor 202 and various sensors 204-218 for measuring various parameters of the vehicle. In gas-powered or hybrid vehicles having a fuel-powered engine, the sensors may include, for example, an engine temperature sensor 204, a battery voltage sensor 206, an engine Revolutions Per Minute (RPM) sensor 208, and a throttle position sensor 210. If the vehicle is an electric or hybrid vehicle, then the vehicle may have an electric motor, and accordingly will have sensors such as a battery monitoring system 212 (to measure current, voltage and/or temperature of the battery), motor current 214 and voltage 216 sensors, and motor position sensors 218 such as resolvers and encoders 218.

Operational parameter sensors that are common to both types of vehicles include, for example: a position sensor 236 such as an accelerometer, gyroscope and/or inertial measurement unit; a speed sensor 238; and an odometer sensor 240. The vehicle also may have a clock 242 that the system uses to determine vehicle time during operation. The clock 242 may be encoded into the vehicle on-board computing device 220, it may be a separate device, or multiple clocks may be available.

The vehicle also will include various sensors that operate to gather information about the environment in which the vehicle is traveling. These sensors may include, for example: a location sensor 260 (for example, a GPS device); object detection sensors such as one or more cameras 262; a lidar sensor system 264; and/or a RADAR and/or SONAR system 266. The sensors also may include environmental sensors 268 such as a precipitation sensor and/or ambient temperature sensor. The object detection sensors may enable the vehicle to detect objects that are within a given distance range of the vehicle in any direction, while the environmental sensors collect data about environmental conditions within the vehicle's area of travel.

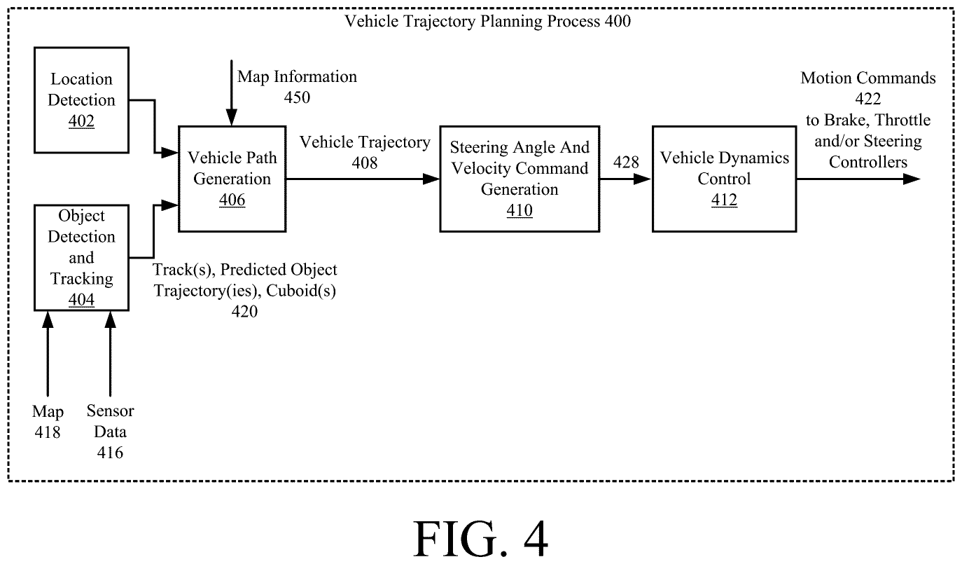

During operations, information is communicated from the sensors to a vehicle on-board computing device 220. The vehicle on-board computing device 220 may be implemented using the computer system of FIG. 4. The vehicle on-board computing device 220 analyzes the data captured by the sensors and optionally controls operations of the vehicle based on results of the analysis. For example, the vehicle on-board computing device 220 may control: braking via a brake controller 222; direction via a steering controller 224; speed and acceleration via a throttle controller 226 (in a gas-powered vehicle) or a motor speed controller 228 (such as a current level controller in an electric vehicle); a differential gear controller 230 (in vehicles with transmissions); and/or other controllers. Auxiliary device controller 254 may be configured to control one or more auxiliary devices, such as testing systems, auxiliary sensors, mobile devices transported by the vehicle, etc.

Geographic location information may be communicated from the location sensor 260 to the vehicle on-board computing device 220, which may then access a map of the environment that corresponds to the location information to determine known fixed features of the environment such as streets, buildings, stop signs and/or stop/go signals. Captured images from the cameras 262 and/or object detection information captured from sensors such as lidar system 264 is communicated from those sensors to the vehicle on-board computing device 220. The object detection information and/or captured images are processed by the vehicle on-board computing device 220 to detect objects in proximity to the vehicle. Any known or to be known technique for making an object detection based on sensor data and/or captured images can be used in the embodiments disclosed in this document.

Lidar information is communicated from lidar system 264 to the vehicle on-board computing device 220. Additionally, captured images are communicated from the camera(s) 262 to the vehicle on-board computing device 220. The lidar information and/or captured images are processed by the vehicle on-board computing device 220 to detect objects in proximity to the vehicle. The manner in which the object detections are made by the vehicle on-board computing device 220 includes such capabilities detailed in this disclosure.

In addition, the system architecture 200 may include an onboard display device 270 that may generate and output an interface on which sensor data, vehicle status information, or outputs generated by the processes described in this document are displayed to an occupant of the vehicle. The display device may include, or a separate device may be, an audio speaker that presents such information in audio format.

The vehicle on-board computing device 220 may include and/or may be in communication with a routing controller 232 that generates a navigation route from a start position to a destination position for an autonomous vehicle. The routing controller 232 may access a map data store to identify possible routes and road segments that a vehicle can travel on to get from the start position to the destination position. The routing controller 232 may score the possible routes and identify a preferred route to reach the destination. For example, the routing controller 232 may generate a navigation route that minimizes Euclidean distance traveled or other cost function during the route, and may further access the traffic information and/or estimates that can affect an amount of time it will take to travel on a particular route. Depending on implementation, the routing controller 232 may generate one or more routes using various routing methods, such as Dijkstra's algorithm, Bellman-Ford algorithm, or other algorithms. The routing controller 232 may also use the traffic information to generate a navigation route that reflects expected conditions of the route (for example, current day of the week or current time of day, etc.), such that a route generated for travel during rush-hour may differ from a route generated for travel late at night. The routing controller 232 may also generate more than one navigation route to a destination and send more than one of these navigation routes to a user for selection by the user from among various possible routes.

In some scenarios, the vehicle on-board computing device 220 may determine perception information of the surrounding environment of the vehicle. Based on the sensor data provided by one or more sensors and location information that is obtained, the vehicle on-board computing device 220 may determine perception information of the surrounding environment of the vehicle. The perception information may represent what an ordinary driver would perceive in the surrounding environment of a vehicle. The perception data may include information relating to one or more objects in the environment of the vehicle. For example, the vehicle on-board computing device 220 may process sensor data (for example, lidar data, RADAR data, camera images, etc.) in order to identify objects and/or features in the environment of vehicle. The objects may include, but is not limited to, traffic signals, roadway boundaries, other vehicles, pedestrians, and/or obstacles. The vehicle on-board computing device 220 may use any now or hereafter known object recognition algorithms, video tracking algorithms, and computer vision algorithms (for example, track objects frame-to-frame iteratively over a number of time periods) to determine the perception.

In those or other scenarios, the vehicle on-board computing device 220 may also determine, for one or more identified objects in the environment, the current state of the object. The state information may include, without limitation, for each object: a current location; a current speed; an acceleration; a current heading; a current pose; a current shape, size and/or footprint; an object type or classification (for example, vehicle, pedestrian, bicycle, static object, or obstacle); and/or other state information.

The vehicle on-board computing device 220 may perform one or more prediction and/or forecasting operations. For example, the vehicle on-board computing device 220 may predict future locations, trajectories, and/or actions of one or more objects. For example, the vehicle on-board computing device 220 may predict the future locations, trajectories, and/or actions of the objects based at least in part on perception information (for example, the state data for each object comprising an estimated shape and pose determined as discussed below), location information, sensor data, and/or any other data that describes the past and/or current state of the objects, the vehicle, the surrounding environment, and/or their relationship(s). For example, if an object is a vehicle and the current driving environment includes an intersection, the vehicle on-board computing device 220 may predict whether the object will likely move straight forward or make a turn. If the perception data indicates that the intersection has no traffic light, the vehicle on-board computing device 220 may also predict whether the vehicle may have to fully stop prior to entering the intersection.

In those or other scenarios, the vehicle on-board computing device 220 may determine a motion plan for the vehicle. For example, the vehicle on-board computing device 220 may determine a motion plan for the vehicle based on the perception data and/or the prediction data. Specifically, given predictions about the future locations of proximate objects and other perception data, the vehicle on-board computing device 220 can determine a motion plan for the vehicle that best navigates the vehicle relative to the objects at their future locations.

In those or other scenarios, the vehicle on-board computing device 220 may receive predictions and make a decision regarding how to handle objects and/or actors in the environment of the vehicle. For example, for a particular actor (for example, a vehicle with a given speed, direction, turning angle, etc.), the vehicle on-board computing device 220 decides whether to overtake, yield, stop, and/or pass based on, for example, traffic conditions, map data, state of the autonomous vehicle, etc. Furthermore, the vehicle on-board computing device 220 also plans a path for the vehicle to travel on a given route, as well as driving parameters (for example, distance, speed, and/or turning angle). That is, for a given object, the vehicle on-board computing device 220 decides what to do with the object and determines how to do it. For example, for a given object, the vehicle on-board computing device 220 may decide to pass the object and may determine whether to pass on the left side or right side of the object (including motion parameters such as speed). The vehicle on-board computing device 220 may also assess the risk of a collision between a detected object and the vehicle. If the risk exceeds an acceptable threshold, it may determine whether the collision can be avoided if the vehicle follows a defined vehicle trajectory and/or implements one or more dynamically generated emergency maneuvers in a time period (for example, N milliseconds). If the collision can be avoided, then the vehicle on-board computing device 220 may execute one or more control instructions to perform a cautious maneuver (for example, mildly slow down, accelerate, change lane, or swerve). In contrast, if the collision cannot be avoided, then the vehicle on-board computing device 220 may execute one or more control instructions for execution of an emergency maneuver (for example, brake and/or change direction of travel).

As discussed above, planning and control data regarding the movement of the vehicle is generated for execution. The vehicle on-board computing device 220 may, for example: control braking via a brake controller; direction via a steering controller; speed and acceleration via a throttle controller (in a gas-powered vehicle) or a motor speed controller (such as a current level controller in an electric vehicle); change gears via a differential gear controller (in vehicles with transmissions); and/or control other operations via other controllers.

A backup computer system 280 may also be provided in system 200. The backup computer system can have the same functionality as the vehicle on-board computing device 220 such that the vehicle can operate as intended even when the vehicle on-board computing device 220 is not operating in an expected manner. The backup computer system 280 may alternatively or additionally perform operations other than those performed by the vehicle on-board computing device 220. For example, the backup computer system 280 may perform diagnostic and/or health monitoring operations relating to the vehicle on-board computing device 220 and/or other components of system 200.

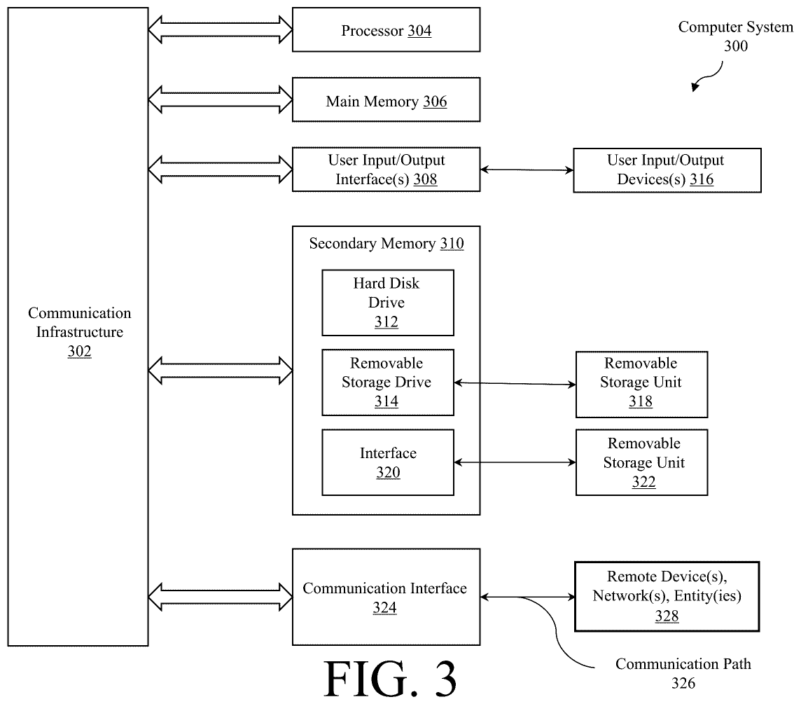

Thus, the present solution can be implemented, for example, using one or more computer systems, such as computer system 300 shown in FIG. 3. Computer system 300 can be any computer capable of performing the functions described herein. The on-board computing device 122 of FIG. 1, computing device 110 of FIG. 1, robotic device(s) 152 of FIG. 1, mobile communication device(s) 156 of FIG. 1, the vehicle on-board computing device 220 of FIG. 2, and/or backup computer system 280 of FIG. 2 may be the same as or similar to computing system 300. As such, the discussion of computing system 300 is sufficient for understanding the devices 110, 122, 152, 156, 220 and 280 of FIGS. 1-2.

Computing system 300 may include more or less components than those shown in FIG. 3. However, the components shown are sufficient to disclose an illustrative solution implementing the present solution. The hardware architecture of FIG. 3 represents one implementation of a representative computing system configured to operate a vehicle, as described herein. As such, the computing system 300 of FIG. 3 implements at least a portion of the method(s) described herein.

Some or all components of the computing system 300 can be implemented as hardware, software and/or a combination of hardware and software. The hardware includes, but is not limited to, one or more electronic circuits. The electronic circuits can include, but are not limited to, passive components (for example, resistors and capacitors) and/or active components (for example, amplifiers and/or microprocessors). The passive and/or active components can be adapted to, arranged to and/or programmed to perform one or more of the methodologies, procedures, or functions described herein.

Computer system 300 includes one or more processors (also called central processing units, or CPUs), such as a processor 304. Processor 304 is connected to a communication infrastructure or bus 302. One or more processors 304 may each be a graphics processing unit (GPU). In some scenarios, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 also includes user input/output device(s) 316, such as monitors, keyboards, pointing devices, etc., that communicate with communication infrastructure 302 through user input/output interface(s) 308. Computer system 300 further includes a main or primary memory 306, such as random access memory (RAM). Main memory 306 may include one or more levels of cache. Main memory 306 has stored therein control logic (i.e., computer software) and/or data.

One or more secondary storage devices or memories 310 may be provided with computer system 300. Secondary memory 310 may include, for example, a hard disk drive 312 and/or a removable storage device or drive 314. Removable storage drive 314 may be an external hard drive, a universal serial bus (USB) drive, a memory card such as a compact flash card or secure digital memory, a floppy disk drive, a magnetic tape drive, a compact disc drive, an optical storage device, a tape backup device, and/or any other storage device/drive.

Removable storage drive 314 may interact with a removable storage unit 318. Removable storage unit 318 includes a computer usable or readable storage device having stored thereon computer software (control logic) and/or data. Removable storage unit 318 may be an external hard drive, a universal serial bus (USB) drive, a memory card such as a compact flash card or secure digital memory, a floppy disk, a magnetic tape, a compact disc, a DVD, an optical storage disk, and/or any other computer data storage device. Removable storage drive 314 reads from and/or writes to removable storage unit 314 in a well-known manner.

In some scenarios, secondary memory 310 may include other means, instrumentalities or other approaches for allowing computer programs and/or other instructions and/or data to be accessed by computer system 300. Such means, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 enables computer system 300 to communicate and interact with any combination of remote devices, remote networks, remote entities, etc. (individually and collectively referenced by reference number 328). For example, communication interface 324 may allow computer system 300 to communicate with remote devices 328 over communications path 326, which may be wired and/or wireless, and which may include any combination of LANs, WANs, the Internet, etc. Control logic and/or data may be transmitted to and from computer system 300 via communication path 326.

In some scenarios, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 300, main memory 306, secondary memory 310, and removable storage units 318 and 322, as well as tangible articles of manufacture embodying any combination of the foregoing. Such control logic, when executed by one or more data processing devices (such as computer system 300), causes such data processing devices to operate as described herein.

Based on the teachings contained in this disclosure, it will be apparent to persons skilled in the relevant art(s) how to make and use the present solution using data processing devices, computer systems and/or computer architectures other than that shown in FIG. 3. In particular, the present solution can operate with software, hardware, and/or operating system implementations other than those described herein.

FIG. 4 provides a block diagram that is useful for understanding how motion or movement of an AV is achieved. All of the operations performed in blocks 402-406, 410, 412 can be performed by the on-board computing device (for example, on-board computing device 122 of FIGS. 1 and/or 220 of FIG. 2) of a vehicle (for example, AV 102 of FIG. 1).

In block 402, a location of the AV (for example, AV 102 of FIG. 1) is detected. This detection can be made based on sensor data output from a location sensor (for example, location sensor 260 of FIG. 2) of the AV. This sensor data can include, but is not limited to, GPS data. The detected location of the AV is then passed to block 406.

In block 404, an object (for example, vehicle 103 of FIG. 1) is detected within proximity of the AV (for example, <100+ meters) using sensor data 416. This detection is made based on sensor data output from a camera (for example, camera 262 of FIG. 2) of the AV and/or a lidar system (for example, lidar system 264 of FIG. 2) of the AV. For example, image processing is performed to detect an instance of an object of a certain class (for example, a vehicle, cyclist or pedestrian) in an image. The image processing/object detection can be achieved in accordance with any known or to be known image processing/object detection algorithm.

Additionally, a predicted trajectory is determined in block 404 for the object. The object's trajectory is predicted in block 404 based on the object's class, cuboid geometry(ies), cuboid heading(s) and/or contents of a map 418 (for example, sidewalk locations, lane locations, lane directions of travel, driving rules, etc.). The manner in which the cuboid geometry(ies) and heading(s) are determined will become evident as the discussion progresses. At this time, it should be noted that the cuboid geometry(ies) and/or heading(s) are determined using sensor data of various types (for example, 2D images, 3D lidar point clouds) and the map 418 (for example, lane geometries). Techniques for predicting object trajectories based on cuboid geometries and headings may include, for example, predicting that the object is moving on a linear path in the same direction as the heading direction of a cuboid. The predicted object trajectories can include, but are not limited to, the following trajectories: a trajectory defined by the object's actual speed (for example, 1 mile per hour) and actual direction of travel (for example, west); a trajectory defined by the object's actual speed (for example, 1 mile per hour) and another possible direction of travel (for example, south, south-west, or X (for example, 40°) degrees from the object's actual direction of travel in a direction towards the AV) for the object; a trajectory defined by another possible speed for the object (for example, 2-10 miles per hour) and the object's actual direction of travel (for example, west); and/or a trajectory defined by another possible speed for the object (for example, 2-10 miles per hour) and another possible direction of travel (for example, south, south-west, or X (for example, 40°) degrees from the object's actual direction of travel in a direction towards the AV) for the object. The possible speed(s) and/or possible direction(s) of travel may be pre-defined for objects in the same class and/or sub-class as the object. It should be noted once again that the cuboid defines a full extent of the object and a heading of the object. The heading defines a direction in which the object's front is pointed, and therefore provides an indication as to the actual and/or possible direction of travel for the object.

Information 420 specifying track(s), the object's predicted trajectory, the cuboid geometry(ies)/heading(s) is provided to block 406. In some scenarios, a classification of the object is also passed to block 406. In block 406, a vehicle trajectory is generated using the information from blocks 402 and 404. Techniques for determining a vehicle trajectory using cuboids may include, for example, determining a trajectory for the AV that would pass the object when the object is in front of the AV, the cuboid has a heading direction that is aligned with the direction in which the AV is moving, and the cuboid has a length that is greater than a threshold value. The present solution is not limited to the particulars of this scenario. The vehicle trajectory 408 can be determined based on the location information from block 402, the object detection information from block 404, and/or map information 450 (which is pre-stored in a data store of the vehicle). The map information 450 may include, but is not limited to, all or a portion of road map(s) 160 of FIG. 1. The vehicle trajectory 408 may represent a smooth path that does not have abrupt changes that would otherwise provide passenger discomfort. For example, the vehicle trajectory is defined by a path of travel along a given lane of a road in which the object is not predicted to travel within a given amount of time. The vehicle trajectory 408 is then provided to block 408.

In block 408, a steering angle and velocity command is generated based on the vehicle trajectory 408. The steering angle and velocity command 428 is provided to block 412 for vehicle dynamics control, i.e., the steering angle and velocity command causes the AV to follow the vehicle trajectory 408.

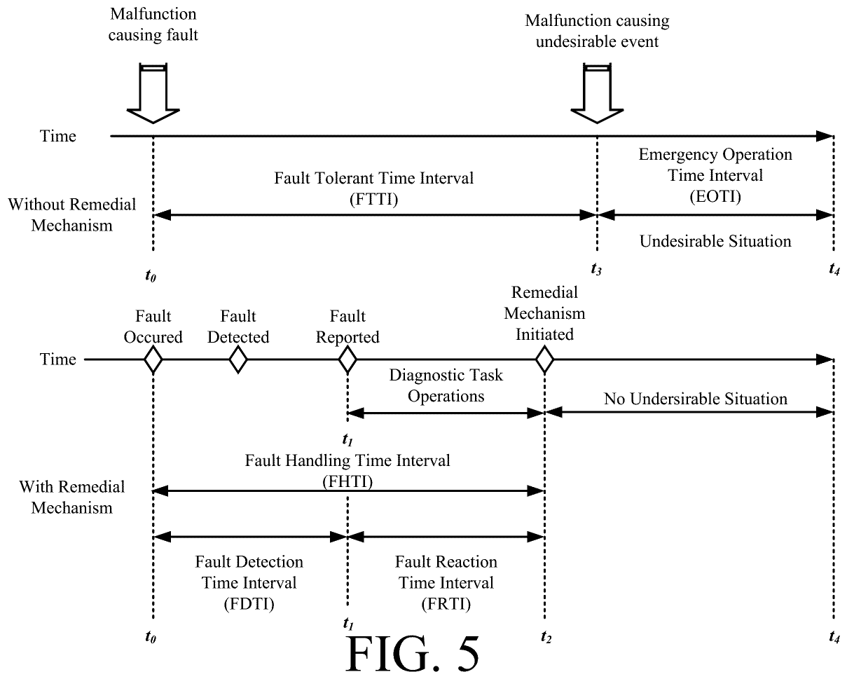

During operations, the vehicle performs operations to detect faults and respond to faults occurring in blocks 402, 404, 406 and/or other hardware/software components. The timing of these operations is shown in FIG. 5. In FIG. 5, a malfunction in the vehicle occurs at time to. At time t₃, the malfunction causes an undesirable event followed by an undesirable situation that lasts until time t₄. The time period between time to and time t₃ is referred to as a fault tolerant time interval (FTTI). The time period between time t₃ and time t₄ is referred to as an Emergency Operation Time Interval (EOTI).

In order to prevent the fault from turning into an undesirable situation, the fault is detected, reported and handled within a fault handling time interval (FHTI). The FHTI comprises two parts, namely a fault detection time interval (FDTI) and a fault reaction time interval (FRTI). The FHTI can therefore comprise the sum of FDTI and FRTI, which is less than FTTI. The present solution is configured to detect, report and react to faults occurring in relation to vehicle software and/or hardware during the FHTI. One or more remedial mechanisms are initiated at time t₂ to prevent or reduce a likelihood (or probability) of an undesirable situation during a time period between t₂ and time t₄. The remedial mechanism can include, but is not limited to, a trajectory gate and/or a motion command gate. Operations of the trajectory gate and/or motion command gate will become evident as the discussion progresses.

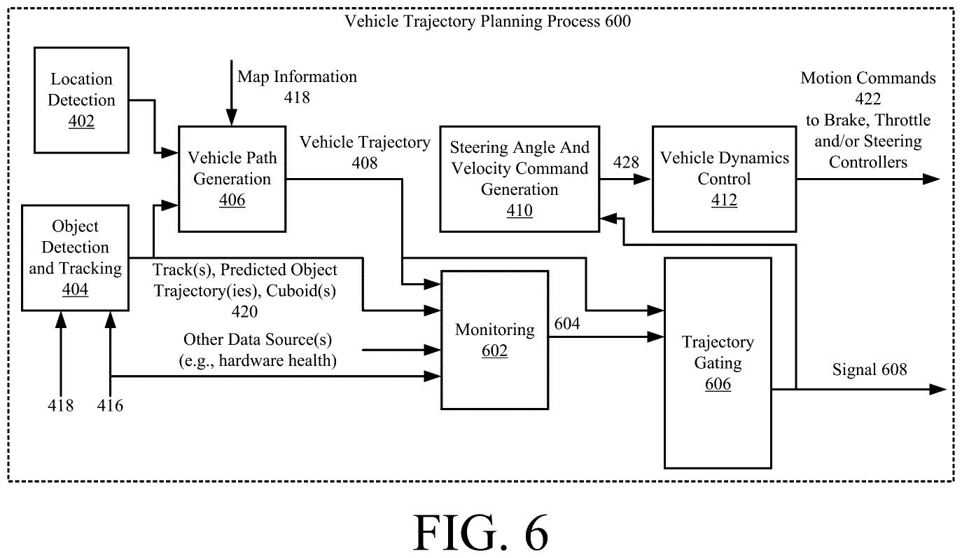

FIG. 6 provides an illustration of a vehicle trajectory planning process 600 implementing the present solution. The vehicle trajectory planning process 600 comprises the operations of the vehicle trajectory planning process 400 discussed above in relation to FIG. 4. The same reference numbers are used in FIG. 6 for these common operations 402-412, 416, 418, 422, 428. The vehicle trajectory planning process 600 additionally includes monitoring operations(s) 602 and a trajectory gating operation 606. The vehicle trajectory planning process 600 can be implemented by one or more computing devices/systems (for example, the on-board computing device 122 of FIG. 1, sever 110 of FIG. 1, the vehicle onboard computing device 220 of FIG. 2, the backup computer system 280 of FIG. 2, processor 304 of FIG. 3, and/or computer system 300 of FIG. 3).

Operations 602, 606 are generally configured to collectively provide a functional guarantor of vehicle trajectory health eliminating or reducing faults and failures from cascading through the system into path followers (for example, operations implemented in block 410), vehicle motion controls (for example, operations implemented in block 412) and/or other downstream operations (for example, backup computer system operations, cooperative perception system operations, diagnostic system operations, fault management system operations, etc.). Operations 602 and/or 606 can be implemented on one computer system (for example, the on-board computing device 122 of FIG. 1 or the vehicle onboard computing device 220 of FIG. 2) or multiple computer systems (for example, the on-board computing device 122 of FIG. 1, sever 110 of FIG. 1, the vehicle onboard computing device 220 of FIG. 2, and/or backup computer system 280 of FIG. 2). The computer systems may be diverse.

In block 602, various information is received. This information includes, but is not limited to, the vehicle trajectory 408, the sensor data and its status 416, the track(s)/predicted object trajectory(ies)/cuboid(s) 420, and/or data from other source(s) (for example, other software functions such as object detection and tracking 404, location detection 402, other software monitors and known or to be known hardware health monitors 286 of FIG. 2). The received information is used to monitor operations of various components of the vehicle (for example, vehicle 102 of FIG. 1) and to identify which of the monitored operations produced data used to generate the vehicle trajectory 408. Such monitored operations can be identified, for example, using timestamps, cycle identifiers, operation identifiers, data identifiers, known timing scheme(s), known identifier scheme(s), and/or hierarchical trees. The timestamps and identifiers may be included in the metadata of the data used to generate the vehicle trajectory 408. For example, all data used to generate a given vehicle trajectory can have identifiers with a portion thereof including at least one sequence of symbols that are common to each other. Thus, this data can be easily identified in block 602 as being associated with the given vehicle trajectory. Additionally or alternatively, timestamps can be included in the metadata of the data used to generate vehicle trajectories. The data used to generate the given vehicle trajectory can be identified in block 602 based on the timestamps and a known timing scheme for the operations that generated the data. The timing schema can specify expected durations of time between completions of operations (for example, 100 microseconds between lidar image generation and object detection, 100 microseconds between object detection and predicted object trajectory generation, etc.). The present solution is not limited to the particulars of this example.

In block 602, operations are also performed to: detect whether the hardware and/or software that produced any of the identified data experienced fault(s) or operational condition(s) of given type(s) (for example, a fault or operational condition that could cause an undesirable situation such as an uncomfortable ride, a flat tire, transmission failure, a collision and/or an explosion); and/or detect whether the vehicle trajectory 408 will cause a violation of pre-defined limits for operational parameters of the vehicle (for example, a maximum longitudinal jerk or a maximum steering wheel angle). These detections can be made in accordance with known techniques that may employ look-up table (LUT) operations and/or comparison operations. For example, a detection is made as to which hardware and/or software that produced any of the identified data experienced a fault or operational condition of the given type when a fault identifier received at block 602 from a data source matches a fault identifier in a pre-stored table and/or when a measured circuit temperature (or other circuit condition) exceeds a pre-defined maximum circuit temperature (or other circuit condition) stored in a pre-defined LUT. A detection is made that the vehicle trajectory 408 will cause a violation of pre-defined limits for operational parameters of the vehicle when a steering wheel angle of the vehicle would exceed a known maximum steering wheel angle if the vehicle trajectory is followed by the vehicle. These detections may additionally or alternatively be made using plausibility errors such as likelihood values below or exceeding acceptable thresholds or actor path predictions intersecting the vehicle's trajectory. The present solution is not limited to the particulars of this example.

A determination is made in block 602 that a fault condition does exit in relation to the vehicle trajectory 408 when a detection is made that the hardware and/or software did experience fault(s) of the given type(s) when producing the identified data and/or when a detection is made that the pre-defined limit(s) will be violated if the vehicle trajectory 408 is followed by the vehicle. A determination is made in block 602 that a fault condition does not exist in relation to the vehicle trajectory 408 when a detection is made that the hardware and/or software did not experience fault(s) of the given type(s) when producing the identified data and/or when a detection is made that the pre-defined limit(s) will not be violated if the vehicle trajectory 408 is followed by the vehicle. It should be noted that this determination could additionally or alternatively be made in blocks 402, 404 and/or 406.

Upon making such a determination, a signal 604 is generated in block 602 and passed to block 606. The signal indicates whether a fault condition does or does not exist in relation to the vehicle trajectory 408. For example, the signal 604 can include an OK signal when a determination is made in block 602 that a fault condition does not exist and an NOK signal when a determination is made in block 602 that a fault condition does exist. The present solution is not limited to the particulars of this example.

In block 606, one or more vehicle trajectories 408 is buffered or otherwise temporarily stored. For example, the system may employ an escape trajectory that is published per cycle of 406. The trajectory gating operation may have the responsibility to pass the escape trajectory to the path followers. The present solution is not limited to the particulars of this example. A signal 608 is generated that includes information selected based on the contents of signal 604. More specifically, signal 608 comprises the vehicle trajectory 408 when signal 604 indicates that a fault condition does not exist in relation to the vehicle trajectory 408 (for example, in the OK scenario). In contrast, signal 608 comprises a modified version of the vehicle trajectory 408 or a last received valid vehicle trajectory when signal 604 indicates that a fault condition does exist in relation to the vehicle trajectory 408 (for example, in the NOK scenario). The modified version of the vehicle trajectory 408 can be generated in accordance with a pre-defined algorithm, pre-defined configuration file(s), and/or pre-defined operational profile(s). For example, a pre-defined offset can be added to and/or subtracted from x-axis coordinate(s), y-axis coordinate(s) and/or x-axis coordinate(s) of the vehicle trajectory when a maximum steering angle limit would be exceeded if the vehicle trajectory is followed. The pre-defined offset can include any number such as N meters, where N is an integer between 0 and 100. Alternatively or additionally, a vehicle speed can be reduced when an acceleration limit would be exceeded if the vehicle trajectory is followed. The present solution is not limited in this regard. The last received valid vehicle trajectory comprises a vehicle trajectory that is stored in the buffer or other temporary datastore so as to be associated with (i) a timestamp indicating that it was generated (for example, in block 406 of FIG. 4) prior to the vehicle trajectory at issue and after any other vehicle trajectory stored in the buffer or other temporary datastore and/or (ii) a valid designation. The vehicle trajectory 408 may be discarded or otherwise removed from a datastore when a fault condition exists and/or signal 608 has been generated.

Signal 608 is communicated to block 410 so that the vehicle trajectory 408, the escape trajectory, the modified version of the vehicle trajectory 408 or a last received valid vehicle trajectory is used to generate the commands 428. Signal may also be communicated to a backup computer system (for example, optional backup computer system 280 of FIG. 2), a cooperative perception system (for example, server 110 of FIG. 1), a diagnostic system (for example, diagnostic system 282 of FIG. 2), a fault management system (for example, fault management system 284 of FIG. 2), and/or other systems (for example, a system implementing the supervisory layer process described in U.S. Pat. No. 11,167,754 issued on Nov. 9, 2021). Any known or to be known cooperative perception system, diagnostic system and fault management system can be used here.

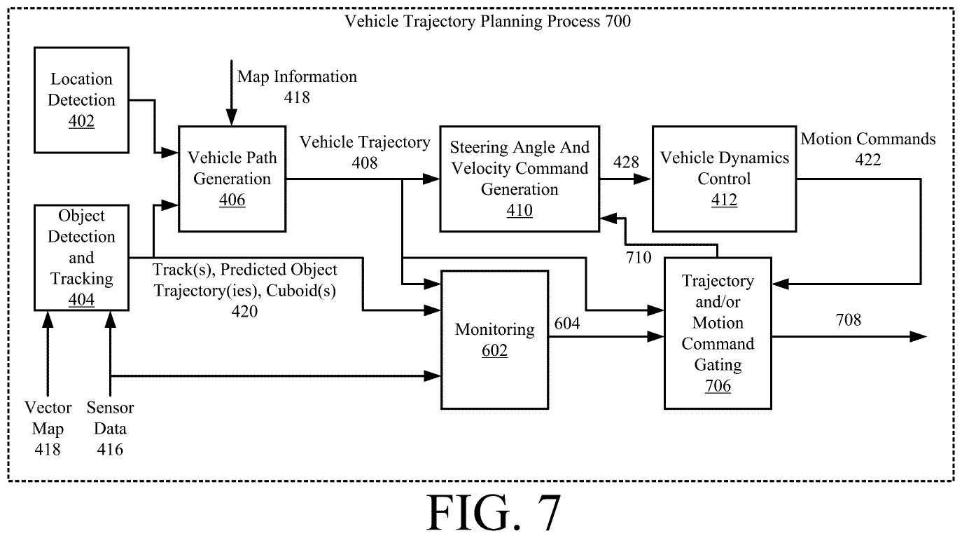

FIG. 7 provides an illustration of a vehicle trajectory planning process 700 implementing the present solution. The vehicle trajectory planning process 700 comprises the operations of the vehicle trajectory planning processes 400, 600 discussed above in relation to FIGS. 4 and 6. The same reference numbers are used in FIG. 7 for these common operations 402-412, 416, 418, 422, 428, 602. The vehicle trajectory planning process 700 additionally includes a trajectory and/or motion command gating operation(s) 706. The vehicle trajectory planning process 700 can be implemented by one or more computing devices/systems (for example, the on-board computing device 122 of FIG. 1, sever 110 of FIG. 1, the vehicle onboard computing device 220 of FIG. 2, the backup computer system 280 of FIG. 2, processor 304 of FIG. 3, and/or computer system 300 of FIG. 3).

Operation 602, 706 are generally configured to: receive health signals from blocks 402, 404, 406; and collectively provide a functional guarantor of vehicle trajectory health eliminating or reducing faults and failures from cascading through the system into path followers (for example, operations implemented in block 410), vehicle motion controls (for example, operations implemented in block 412) and/or other downstream operations (for example, backup computer system operations, cooperative perception system operations, diagnostic system operations, fault management system operations, etc.). Operations 602 and/or 706 can be implemented on one computer system (for example, the on-board computing device 122 of FIG. 1 or the vehicle onboard computing device 220 of FIG. 2) or multiple computer systems (for example, the on-board computing device 122 of FIG. 1, sever 110 of FIG. 1, the vehicle onboard computing device 220 of FIG. 2, and/or backup computer system 280 of FIG. 2). The computer systems may be diverse.

The operations of block 602 are described in detail above in relation to FIG. 6. This discussion will not be repeated here. As noted above, a signal 604 is generated in block 602. Signal 604 is passed to block 706. Signal 604 indicates whether a fault condition does or does not exist in relation to the vehicle trajectory 408. For example, the signal 604 can include an OK signal when a determination is made in block 602 that a fault condition does not exist and an NOK signal when a determination is made in block 602 that a fault condition does exist. The present solution is not limited to the particulars of this example.

In block 706, the vehicle trajectory 408 and/or motion commands 422 are buffered or otherwise temporarily stored. A signal 708 is optionally generated based on the contents of signal 604. When signal 604 indicates that fault(s) has(have) occurred (for example, an NOK scenario), signal 708 is optionally generated and output from block 706. Signal 708 can include: the vehicle trajectory 408 and/or the motion commands 422 with invalid designation(s); and/or a modified version of the vehicle trajectory 408 or a last received valid vehicle trajectory. An invalid designation can include a pre-defined value (for example, “0”). The modified version of the vehicle trajectory 408 can be generated in accordance with a pre-defined algorithm, pre-defined configuration file(s), and/or pre-defined operational profile(s). For example, a pre-defined offset can be added to and/or subtracted from x-axis coordinate(s), y-axis coordinate(s) and/or x-axis coordinate(s) of the vehicle trajectory when a maximum steering angle limit would be exceeded if the vehicle trajectory is followed. The pre-defined offset can include any number such as N meters, where N is an integer between 0 and 100. Alternatively or additionally, a vehicle speed can be reduced when an acceleration limit would be exceeded if the vehicle trajectory is followed. The present solution is not limited in this regard. The vehicle trajectory 408 and/or motion commands 422 may also be discarded or otherwise removed from a datastore in this case.

When signal 604 indicates that fault(s) has(have) not occurred (for example, an OK scenario), signal 708 is generated and output from block 706. Signal 708 can include the vehicle trajectory 408 and/or motion commands with or without valid designation(s). The valid designation can include a pre-defined value (for example, “1”). The vehicle trajectory 408 and/or motion controls may be maintained in the buffer or other datastore until a new valid trajectory and/or motion controls is/are detected in block 706.

Signal 708 is communicated to block 410 so that the vehicle trajectory 408, the modified version of the vehicle trajectory 408 or a last received valid vehicle trajectory is used to generate the commands 428. Signal 708 may also be communicated to a backup computer system (for example, optional backup computer system 280 of FIG. 2), a cooperative perception system (for example, server 110 of FIG. 1), a diagnostic system (for example, diagnostic system 282 of FIG. 2), a fault management system (for example, fault management system 284 of FIG. 2), and/or other systems (for example, a system implementing the supervisory layer process described in U.S. Pat. No. 11,167,754 issued on Nov. 9, 2021). Any known or to be known cooperative perception system, diagnostic system and fault management system can be used here.

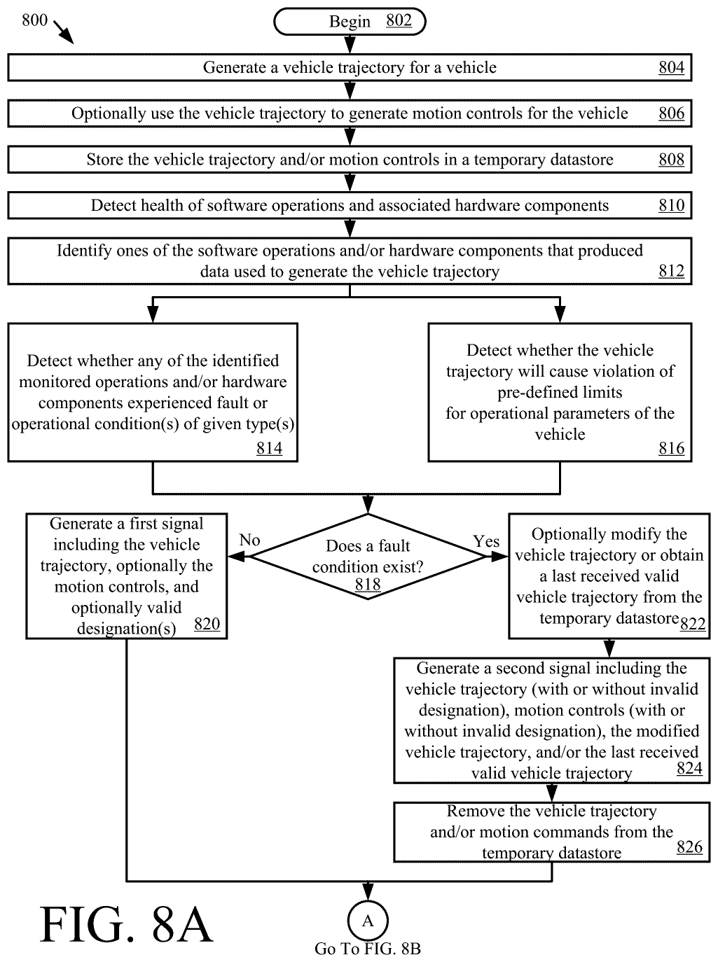

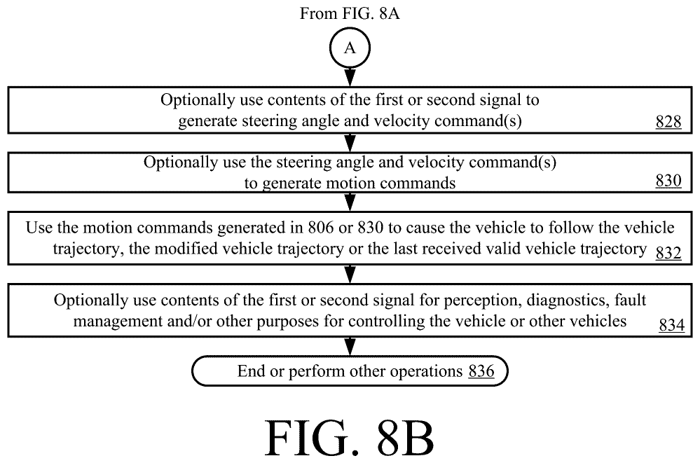

FIG. 8 provides a flow diagram of an illustrative method 800 for selectively using vehicle trajectories (for example, during a run by an autonomous vehicle). Method 800 can be implemented by one or more computing devices/systems (for example, the on-board computing device 122 of FIG. 1, sever 110 of FIG. 1, the vehicle onboard computing device 220 of FIG. 2, the backup computer system 280 of FIG. 2, processor 304 of FIG. 3, and/or computer system 300 of FIG. 3). Method 800 includes a plurality of operations 804-834. The present solution is not limited to the particular order of operations shown in FIG. 8. For example, operations of blocks 812/814 and 816 may be performed in parallel rather than in a sequential manner as shown in FIG. 8A.

Method 800 begins with 802 and continues with 804 where a vehicle trajectory (for example, vehicle trajectory 408 of FIGS. 4, 6 and 7) is generated for a vehicle (for example, vehicle 102 of FIG. 1). The vehicle trajectory can optionally be used in 806 to generate motion controls (for example, motion controls 422 of FIG. 7). The vehicle trajectory and/or motion controls are buffered or otherwise stored in a temporary datastore (for example, memory 306 or 310 of FIG. 3) of the vehicle, as shown by 808.

In 810, software operations of the vehicle are monitored in accordance with known techniques. The health of associated hardware of the vehicle is also monitored in accordance with known techniques. For example, the operations performed in blocks 402, 404 and/or 406 of FIG. 4 are monitored. These operations are performed by software executed by an onboard computing device 122 of FIGS. 1 and/or 220 of FIG. 2 using data generated by a sensor system 118 of FIG. 1. Sensor system 118 can include sensor(s) 236-240, 260-268 of FIG. 2. The heath of the hardware components 118/220, 122, 236-240, 260-268 is monitored. A hardware component may be deemed healthy when its operational conditions (for example, temperature) fall within pre-defined range(s). A hardware component may be deemed unhealthy when its operational condition(s) fall outside of the pre-defined range(s). The present solution is not limited to the particulars of this example.

In 812, operations are performed to identify ones of the monitored operations and/or hardware components that produced data used to generate the vehicle trajectory. Such monitored operations can be identified, for example, using timestamps, cycle identifiers, operation identifiers, data identifiers, known timing scheme(s), known identifier scheme(s), and/or hierarchical trees. The timestamps and identifiers may be included in the metadata of the data used to generate the vehicle trajectory. For example, all data used to generate a given vehicle trajectory can have identifiers with a portion thereof including at least one sequence of symbols that are common to each other. Thus, this data can be easily identified in 812 as being associated with the vehicle trajectory. Additionally or alternatively, timestamps can be included in the metadata of the data used to generate vehicle trajectories. The data used to generate the given vehicle trajectory can be identified in 812 based on the timestamps and a known timing scheme for the operations that generated the data. The timing schema can specify expected durations of time between completions of operations (for example, 100 microseconds between lidar image generation and object detection, 100 microseconds between object detection and predicted object trajectory generation, etc.). The present solution is not limited to the particulars of this example.

The hardware components can be identified in 812 using pre-stored information specifying what operations of the vehicle are performed by what hardware components. For example, the pre-stored information can indicate that: lidar system 264 of FIG. 2 produces lidar images used in block 404 of FIG. 4 for object detection and tracking; location/GPS system 260 of FIG. 2 produced location data used in block 402 of FIG. 4 for location detection; and so on. The present solution is not limited to the particulars of this example.

Next in 814 and 816, the computing device/system performs operations to: detect whether any of the identified monitored software operations and/or hardware components experience fault(s) of given type(s) and/or operational condition(s) of given type(s); and detect whether the vehicle trajectory will cause violation of pre-defined limits for operational parameters of the vehicle. The given type(s) of fault(s) and/or operational condition(s) can include that (those) which could cause an undesirable situation such as an uncomfortable ride, a flat tire, transmission failure, a collision and/or an explosion. These detections can be made in accordance with known techniques that may employ LUT operations and/or comparison operations. For example, a detection is made as to which hardware and/or software that produced any of the identified data experienced a fault or operational condition of the given type when a fault identifier received from the same matches a fault identifier in a pre-stored table and/or when a measured circuit temperature (or other circuit condition) exceeds a pre-defined maximum circuit temperature (or other circuit condition) stored in a pre-defined LUT. A detection is made that the vehicle trajectory will cause a violation of pre-defined limits for operational parameters of the vehicle when a steering wheel angle (or other operational parameter value) of the vehicle would exceed a known maximum steering wheel angle (or other maximum operational parameter value) if the vehicle trajectory is followed by the vehicle. The present solution is not limited to the particulars of this example.

The results of these detections are used by the computing device/system in 818 to make a determination as to whether or not a fault condition exists in relation to the vehicle trajectory. A determination is made in 818 that a fault condition does exit in relation to the vehicle trajectory when a detection is made that the identified hardware and/or software did experience fault(s) and/or operational condition(s) of the given type(s) when producing the data used to generate the vehicle trajectory and/or when a detection is made that the pre-defined limit(s) will be violated if the vehicle trajectory is followed by the vehicle. A determination is made in block 818 that a fault condition does not exist in relation to the vehicle trajectory when a detection is made that the identified hardware and/or software did not experience fault(s) and/or operational condition(s) of the given type(s) when producing the data used to generate the vehicle trajectory and/or when a detection is made that the pre-defined limit(s) will not be violated if the vehicle trajectory is followed by the vehicle.

If a determination is made by the computing device/system that a fault detection does not exist [818: NO], then method 800 continues with 820 where a first signal is generated that includes the vehicle trajectory with or without a valid designation. The first signal may also optionally include motion controls with or without a valid designation. The valid designation can include a pre-defined value (for example, “1”). The valid designation(s) may be included in a header of the first signal, a trailer of the first signal or appended in front of or behind the vehicle trajectory and/or motion controls. Thereafter, method 800 continues with 828 of FIG. 8B which will be discussed below.

If a determination is made by the computing device/system that a fault detection does exist [818: YES], then method 800 continues with 822 where the computing device/system optionally modifies the vehicle trajectory or obtains a last received valid vehicle trajectory from the buffer or other temporary datastore. The modified version of the vehicle trajectory can be generated in accordance with a pre-defined algorithm, pre-defined configuration file(s), and/or pre-defined operational profile(s). For example, a pre-defined offset can be added to and/or subtracted from x-axis coordinate(s), y-axis coordinate(s) and/or x-axis coordinate(s) of the vehicle trajectory when a maximum steering angle limit would be exceeded if the vehicle trajectory is followed. The pre-defined offset can include any number such as N meters, where N is an integer between 0 and 100. Alternatively or additionally, a vehicle speed of the vehicle trajectory can be reduced when an acceleration limit would be exceeded if the vehicle trajectory is followed. The present solution is not limited in this regard. The last received valid vehicle trajectory comprises a vehicle trajectory that is stored in the buffer or other temporary datastore so as to be associated with (i) a timestamp indicating that it was generated (for example, in block 406 of FIG. 4) prior to the vehicle trajectory at issue and after any other vehicle trajectory stored in the buffer or other temporary datastore and/or (ii) a valid designation.

A second signal is generated in 824 that includes the vehicle trajectory with or without an invalid designation, the motion controls with or without an invalid designation, the modified vehicle trajectory, and/or the last received valid vehicle trajectory. The vehicle trajectory and/or motion commands are removed from the buffer or other temporary datastore in 826. Thereafter, method 800 continues with optional 828 of FIG. 8B.

As shown in FIG. 8B, 828 involves optionally using contents of the first or second signal to generate steering angle and velocity command(s). More specifically, the steering angle and velocity command(s) are generated using the vehicle trajectory when a fault condition does not exist and the modified vehicle trajectory or the last received valid vehicle trajectory when the fault condition does exist. The steering angle and velocity command(s) may be used to generate motion commands as shown by optional 830.

The motion commands generated in 806 or 830 are used in 832 to cause the vehicle to follow the vehicle trajectory, the modified vehicle trajectory or the last received valid vehicle trajectory. The contents of the first or second signal may also optionally be used in 834 for vehicle perception, cooperative perception, vehicle diagnostic, vehicle fault management and/or other purposes for controlling operations of the vehicle or other vehicle(s) (for example, vehicle 103 of FIG. 1). Any known or to be known technique for perception, cooperative perception, vehicle diagnostic and vehicle fault management can be used here. Subsequently, 836 is performed where method 800 ends or other operations are performed (for example, return to 804 of FIG. 8A).

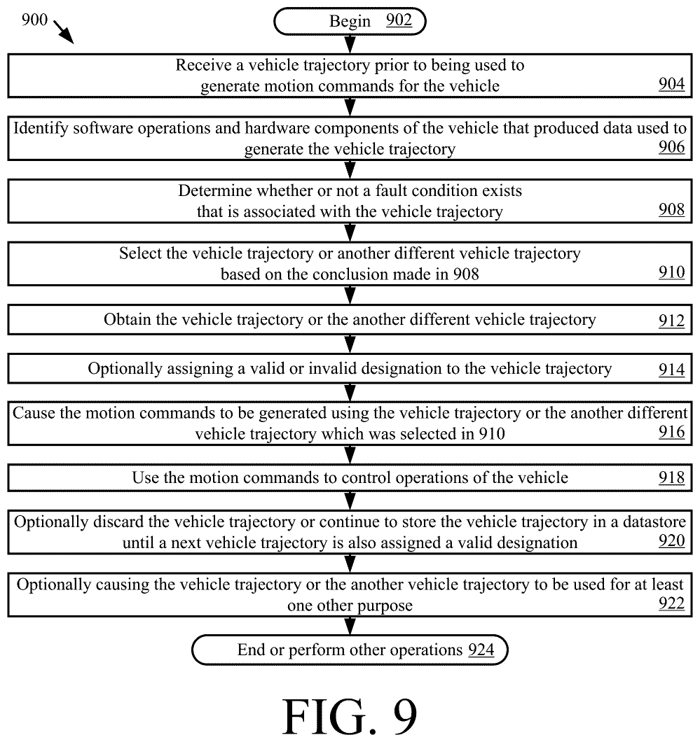

Referring now to FIG. 9, there is provided a flow diagram of another method 900 for selectively using vehicle trajectories (for example, during a run by an autonomous vehicle). Method 900 can be implemented by one or more computing devices/systems (for example, the on-board computing device 122 of FIG. 1, sever 110 of FIG. 1, the vehicle onboard computing device 220 of FIG. 2, the backup computer system 280 of FIG. 2, processor 304 of FIG. 3, and/or computer system 300 of FIG. 3). Method 900 includes a plurality of operations 904-922. The present solution is not limited to the particular order of operations shown in FIG. 9.

Method 900 begins with 902 and continues with 904 where the computing device/system receives a vehicle trajectory (for example, vehicle trajectory 408 of FIGS. 4, 6 and 7) prior to being used to generate motion commands (for example, motion commands 422 of FIGS. 4, 6 and 7) for the vehicle (for example, vehicle 102 of FIG. 1). Next in 906, the computing device/system performs operations to identify software operations and hardware components of the vehicle that produced data used to generate the vehicle trajectory.

The computing device/system makes a determination in 908 whether or not a fault condition exists that is associated with the vehicle trajectory. This determination can be made based on (i) a detection that at least one of the identified software operations and hardware components did or did not experience a fault or operational condition of a pre-defined type while producing the data used to generate the vehicle trajectory and/or (ii) a detection that the vehicle trajectory would or would not cause violation of at least one pre-defined limit for an operational parameter of the vehicle. A determination is made that the fault condition exists when a detection is made that at least one of the identified software operations and hardware components did experience a fault or operational condition of a pre-defined type while producing the data used to generate the vehicle trajectory and/or a detection is made that the vehicle trajectory would cause violation of at least one pre-defined limit for an operational parameter of the vehicle. A determination is made that the fault condition does not exist when a detection is made that at least one of the identified software operations and hardware components did not experience a fault or operational condition of a pre-defined type while producing the data used to generate the vehicle trajectory and/or a detection is made that the vehicle trajectory would not cause violation of at least one pre-defined limit for an operational parameter of the vehicle.

In 910, the computing device/system performs operations to select the vehicle trajectory when the fault condition does not exist or to select another different trajectory when the fault condition does exist. The selected trajectory is obtained in 912. The vehicle trajectory can be obtained from a buffer or other temporary datastore. The another different vehicle trajectory can be obtained by modifying the vehicle trajectory or by retrieving a previously received vehicle trajectory from a datastore.

A valid or invalid designation may be assigned to the vehicle trajectory in optional 914. A valid designation is assigned to the vehicle trajectory when the fault condition does not exist. An invalid designation is assigned to the vehicle trajectory when the fault condition does exist.

In 916, the computing device/system causes the motion commands to be generated using the vehicle trajectory or the another different vehicle trajectory which was selected in 910. The motion commands are used in 918 to control operations of the vehicle.

In optional 920, the vehicle trajectory is discarded or otherwise removed from the temporary datastore (for example, when a determination is made in 908 that the fault condition does exist). Alternatively, the computing device/system continues to store the vehicle trajectory in a datastore until a next vehicle trajectory is also assigned a valid designation (for example, when a determination is made in 908 that the fault condition does not exist).

In optional 922, the vehicle trajectory or the another vehicle trajectory which was selected in 910 is used for at least one other purpose such as perception, diagnostics and/or fault management. Any known technique for perception, diagnostics and/or fault management can be used here. Subsequently, 924 is performed where method 900 ends or other operations are performed (for example, return to 904).

The implementing systems of the above-described method(s) can comprise: a processor; and a non-transitory computer-readable storage medium comprising programming instructions that are configured to cause the processor to implement a method for operating an automated system. The above-described methods can also be implemented by a computer program product comprising a memory and programming instructions that are configured to cause a processor to perform operations.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments but should be defined only in accordance with the following claims and their equivalents.

What is claimed is:

1. A method for selectively using vehicle trajectories, comprising:
receiving, by a computing device, a vehicle trajectory prior to being used to generate motion commands for a vehicle;
identifying, by the computing device, software operations and hardware components of the vehicle that produced data used to generate the vehicle trajectory;
determining, by the computing device, whether or not a fault condition exists that is associated with the vehicle trajectory based on at least one of (i) a detection that at least one of the identified software operations and hardware components did or did not experience a fault or operational condition of a type while producing the data used to generate the vehicle trajectory and (ii) a detection that the vehicle trajectory would or would not cause violation of at least one limit for an operational parameter of the vehicle;
performing operations, by the computing device, to select the vehicle trajectory when the fault condition does not exist or to select another vehicle trajectory the fault condition does exist; and
causing the motion commands to be generated using the vehicle trajectory or the another vehicle trajectory which was selected.

2. The method according to claim 1, further comprising using the motion commands to control operations of the vehicle.

3. The method according to claim 1, wherein the fault condition exists when a detection is made that at least one of the identified software operations and hardware components experienced a fault or operational condition of a type while producing the data used to generate the vehicle trajectory or a detection is made that the vehicle trajectory would cause violation of at least one limit for an operational parameter of the vehicle.

4. The method according to claim 1, wherein the fault condition does not exist when a detection is made that at least one of the identified software operations and hardware components did not experience a fault or operational condition of a type while producing the data used to generate the vehicle trajectory or a detection is made that the vehicle trajectory would not cause violation of at least one limit for an operational parameter of the vehicle.

5. The method according to claim 1, wherein the another vehicle trajectory is based on a modification of the vehicle trajectory.

6. The method according to claim 1, wherein the another vehicle trajectory is based on a previously received vehicle trajectory retrieved from a datastore.

7. The method according to claim 1, further comprising discarding the vehicle trajectory when the fault condition does exist.

8. The method according to claim 1, further comprising assigning a valid designation to the vehicle trajectory when the fault condition does not exist.

9. The method according to claim 8, further comprising continuing to store the vehicle trajectory in a datastore until a next vehicle trajectory is also assigned a valid designation.

10. A system, comprising:
a processor;
a non-transitory computer-readable storage medium comprising programming instructions that are configured to cause the processor to implement a method for selectively using vehicle trajectories, wherein the programming instructions comprise instructions to:
receive a vehicle trajectory prior to being used to generate motion commands for a vehicle;
identify software operations and hardware components of the vehicle that produced data used to generate the vehicle trajectory;
determine whether or not a fault condition exists that is associated with the vehicle trajectory based on at least one of (i) a detection that at least one of the identified software operations and hardware components did or did not experience a fault or operational condition of a type while producing the data used to generate the vehicle trajectory and (ii) a detection that the vehicle trajectory would or would not cause violation of at least one limit for an operational parameter of the vehicle;
perform to select the vehicle trajectory when the fault condition does not exist or to select another vehicle trajectory when the fault condition does exist; and
cause the motion commands to be generated using the vehicle trajectory or the another vehicle trajectory which was selected.

11. The system according to claim 10, wherein the programming instructions further comprise instructions to use the motion commands to control operations of the vehicle.

12. The system according to claim 10, wherein the fault condition exists when a detection is made that at least one of the identified software operations and hardware components experienced a fault or operational condition of a type while producing the data used to generate the vehicle trajectory or a detection is made that the vehicle trajectory would cause violation of at least one limit for an operational parameter of the vehicle.

13. The system according to claim 10, wherein the fault condition does not exist when a detection is made that at least one of the identified software operations and hardware components did not experience a fault or operational condition of a type while producing the data used to generate the vehicle trajectory or a detection is made that the vehicle trajectory would not cause violation of at least one limit for an operational parameter of the vehicle.

14. The system according to claim 10, wherein the another vehicle trajectory is based on a modification of the vehicle trajectory.

15. The system according to claim 10, wherein the another vehicle trajectory is based on a previously received vehicle trajectory retrieved from a datastore.

16. The system according to claim 10, wherein the programming instructions further comprise instructions to discard the vehicle trajectory when the fault condition does exist.

17. The system according to claim 10, wherein the programming instructions further comprise instructions to assign a valid designation to the vehicle trajectory when the fault condition does not exist.

18. The system according to claim 17, wherein the programming instructions further comprise instructions to continue to store the vehicle trajectory in a datastore until a next vehicle trajectory is also assigned a valid designation.

19. A non-transitory computer-readable medium that stores instructions that is configured to, when executed by at least one computing device, cause the at least one computing device to perform operations comprising:
receiving a vehicle trajectory prior to being used to generate motion commands for a vehicle;
identifying software operations and hardware components of the vehicle that produced data used to generate the vehicle trajectory;
determining whether or not a fault condition exists that is associated with the vehicle trajectory based on at least one of (i) a detection that at least one of the identified software operations and hardware components did or did not experience a fault or operational condition of a type while producing the data used to generate the vehicle trajectory and (ii) a detection that the vehicle trajectory would or would not cause violation of at least one limit for an operational parameter of the vehicle;
performing operations to select the vehicle trajectory when the fault condition does not exist or to select another vehicle trajectory when the fault condition does exist; and
causing the motion commands to be generated using the vehicle trajectory or the another vehicle trajectory which was selected.

20. The non-transitory computer-readable medium according to claim 19, wherein the at least one computing device is further caused to use the motion commands to control operations of the vehicle.
